(19) United States
(12) Patent Application Publication
(10) Pub. No.: US 2024/0028876 A1
(43) Pub. Date: Jan. 25, 2024

(54) METHODS AND APPARATUS FOR GROUND TRUTH SHIFT FEATURE RANKING

(71) Applicant: Intel Corporation, Santa Clara, CA (US)

(72) Inventors: Anthony Rhodes, Portland, OR (US); Hong Lu, Santa Clara, CA (US); Lama Nachman, Santa Clara, CA (US)

(21) Appl. No.: 18/477,407

(22) Filed: Sep. 28, 2023

(51) Int. Cl. G06N 3/047; G06N 3/084

(52) U.S. Cl. CPC G06N 3/047; G06N 3/084

(57) ABSTRACT

Example apparatus disclosed include interface circuitry, machine readable instruction, and programmable circuitry to at least one of instantiate or execute the machine readable instructions to access source input data and target input data, identify a domain shift prediction based on at least one of a feature decorrelation of the source input data or a feature decorrelation of the target input data, the domain shift prediction a source domain prediction or a target domain prediction, initiate gradient propagation of a domain loss to determine data features for the domain shift prediction, and rank input data features for the domain shift prediction.

### FIELD OF THE DISCLOSURE

This disclosure relates generally to software processing, and, more particularly, to methods, systems, and apparatus for ranking and decorrelating data features under distribution shift setting of predictive models training and inferencing.

### BACKGROUND

Deep neural networks (DNN) such as convolutional neural networks (CNNs) and recurrent neural networks (RNNs) can be used in the context of a variety of fields, including image classification, speech recognition, medical diagnosis, and/or autonomous driving. An increase in the size of datasets and a corresponding increase in DNN complexity results in increases in the computational intensity and memory demands of deep learning-based tasks.

### BRIEF DESCRIPTION OF THE DRAWINGS

FIG. 1 is an example schematic summary of neural feature decorrelation (NFD) performed using example feature decorrelation generator circuitry in accordance with teachings disclosed herein.

FIG. 2 is an example decorrelated distribution shift feature ranking (DDSFR) workflow performed in accordance with teachings disclosed herein.

FIG. 3 is an example decorrelated distribution shift feature ranking (DDSFR) workflow using a Bayesian neural network (BNN) backbone for predictive uncertainty estimation in accordance with teachings disclosed herein.

FIG. 4 is a block diagram representative of the feature decorrelation generator circuitry that may be implemented in the example environment of FIGS. 1, 2, and/or 3.

FIG. 5 is a flowchart representative of example machine-readable instructions and/or example operations that may be executed, instantiated, and/or performed by example programmable circuitry to implement the example feature decorrelation generator circuitry of FIG. 4.

FIG. 6 is a flowchart representative of example machine readable instructions and/or example operations that may be executed, instantiated, and/or performed by example programmable circuitry to implement a computing system of FIG. 4 to cause a computing system to train a joint encoder model.

FIG. 7 is a flowchart representative of example machine-readable instructions and/or example operations that may be executed, instantiated, and/or performed by example programmable circuitry to implement the example feature decorrelation generator circuitry of FIG. 1 to perform neural feature decorrelation in accordance with teachings disclosed herein.

FIG. 8A illustrates example results associated with evaluating the effectiveness of neural feature decorrelation (NFD) for feature ranking and feature selection based on a standard Modified National Institute of Standards and Technology (MNIST) dataset.

FIG. 8B illustrates example results associated with decorrelated distribution shift feature ranking on high-dimensional data shift ground truth prediction and/or domain prediction tasks to evaluate the effectiveness of decorrelated distribution shift feature ranking.

FIG. 9 is a block diagram of an example processing platform including programmable circuitry structured to execute, instantiate, and/or perform the example machine readable instructions and/or perform the example operations of FIGS. 5-7 to implement the feature decorrelation generator circuitry of FIG. 4.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 5, 6 and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Deep neural networks (DNNs) have revolutionized the field of artificial intelligence (AI) as applied in many domains including computer vision, speech processing, and natural language processing. More specifically, neural networks are used in machine learning (ML) to allow a computer to learn to perform certain tasks by analyzing training examples. For example, an object recognition system can be fed labeled images of objects (e.g., cars, trains, animals, etc.) to allow the system to identify visual patterns in such images that consistently correlate with a particular object label. DNNs rely on multiple layers to progressively extract higher-level features from raw data input (e.g., from identifying edges of a human being using lower layers to identifying actual facial features using higher layers, etc.). In particular, convolutional neural networks (CNNs) are widely applied in large-scale computer vision and video recognition applications, including tasks such as style transfer, object tracking, 3D reconstruction, as well as facial and action-based recognition. For example, a CNN can be used to receive images as input and use the received images to train a classifier. For example, the CNN can include a convolution layer, a pooling layer, an activation layer, and a fully connected layer for performing feature learning and classification.

In real-world deployments, predictive models commonly operate on data distributions that differ significantly from training settings. The presence of distribution shift frequently leads to substantial model performance degradation. For example, distribution shift can be challenging to detect and even harder to remedy for complex data modeling problems. Feature selection and feature ranking (e.g., the process of identifying the most information-rich components of a dataset) are vital aspects of all machine learning and related workflows. Model performance, compute/memory efficiency, and/or other related measures are ultimately functions of data efficiency (e.g., the effectiveness of the modeling process with extracting useful structure from data). In high dimensions, multicollinearity (e.g., redundancy in the information contained in predictor variables) is a common challenge, given that two or more predictor values are highly correlated, resulting in feature redundancy. For example, models trained using redundant features tend to underperform, are susceptible to overfitting, and such models are furthermore ineffective for causal inference analysis.

Modern feature selection techniques can be classified into three general categories, including wrapper methods, filter methods, and embedded methods. Wrapper methods use a predictive model to score feature subsets (e.g., prediction accuracy). Such methods require training a new model for each feature subset, and they are therefore very computationally intensive, but nevertheless frequently well-calibrated for a particular type of model or typical problem. Filter methods utilize a proxy measure instead of a problem-specific error rate. Common measures include mutual information, correlation, and intra/inter class distances. Unlike wrapper methods, filter methods tend to be less computationally costly. However, because filter methods use cheaper proxy measures to estimate feature importance, they tend to be less calibrated for a specific predictive model. In contrast, embedded methods define numerous techniques which perform feature selection as an embedded process as part of a larger model training loop (e.g., such as L1 and L0 regularization, decision trees, etc.).

Methods and apparatus disclosed herein introduce simultaneous ranking and decorrelation of data features under distribution shift settings. For example, a distributional shift or domain shift reflects a change in the data distribution between an algorithm's training dataset and a dataset the algorithm encounters during deployment. Arbitrary data distribution changes render training data ineffective when making predictions based on a target domain. As such, successful domain adaptation involves transferring relevant knowledge from the training (e.g., source) domain to the test (e.g., target) domain. In examples disclosed herein, feature importance is identified under distribution shift settings, the features are automatically decorrelated, and predictive inference is extrapolated from a source to a target dataset (e.g., a shifted dataset) without requiring label annotations for target datapoints. In examples disclosed herein, the most important features for a source-to-target domain shift setting are identified. For example, ground truth (GT) values may be available for the source dataset but not for the target dataset. Therefore, a model can be trained to extrapolate ground truth predictions for the target data and shifted data, in addition to predicting the data domain. In examples disclosed herein, a joint encoder model is used to simultaneously predict (e.g., at training time) the domain (e.g., source vs. target) and ground truth values (e.g., for the source dataset). Examples disclosed herein utilize neural feature decorrelation (NFD) for enforcing seamless feature decorrelation via an auxiliary function that minimizes off-diagonal feature covariances of first layer weights of the model. Furthermore, examples disclosed herein apply gradient propagation of the domain loss (e.g., the source domain loss versus the target domain loss) with respect to input features. In some examples, these gradients are averaged over an entire test dataset to determine decorrelated distribution shift feature ranking (DDSFR) scores.

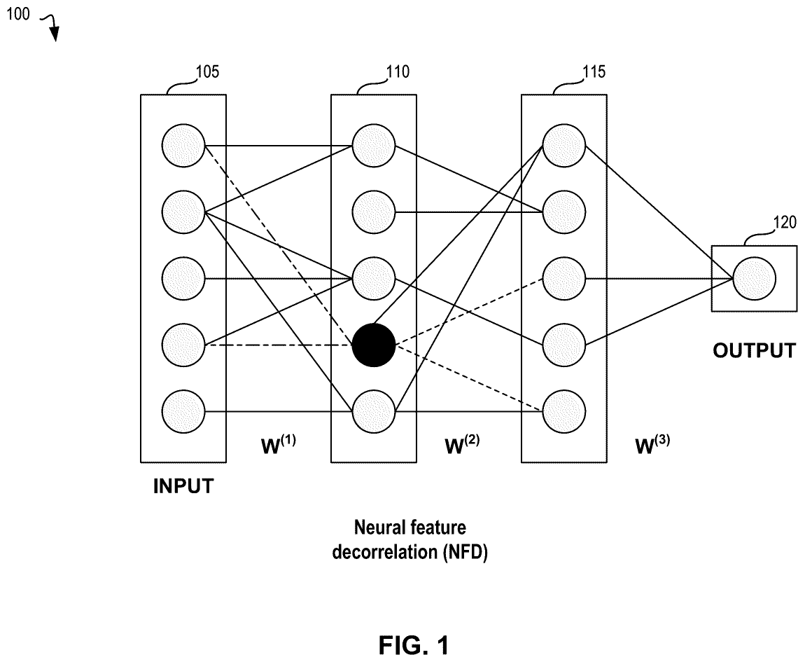

FIG. 1 is an example schematic summary 100 of neural feature decorrelation (NFD) performed using example feature decorrelation generator circuitry in accordance with teachings disclosed herein. For example, decorrelated distribution shift feature ranking (DDSFR) as described herein can include an algorithm to identify the top-k most important features for a source-to-target domain shift setting. In some examples, ground truth values are available for the source dataset, but not for the target dataset. In examples disclosed herein, a model is developed to learn to extrapolate ground truth predictions for the target and shifted data while also predicting the data domain. In examples disclosed herein, NFD approximates feature correlations concurrent to training a neural network. These feature correlations are penalized using an auxiliary loss function to encourage the model to force their decorrelation. For example, if feature X and feature Y are found to be highly correlated, one or the other is processed, but not both features simultaneously. Such a procedure can be applied to any generic machine learning workflow (e.g., particularly neural networks) via a simple loss function, without the need for additional model parameters or extraneous training steps. While NFD has many potential downstream use cases, this decorrelation process is particularly useful for feature ranking and dimensionality reduction. In examples disclosed herein, NFD approximates all feature correlations at an input layer of a neural network by using a specialized loss function. Due to presence of layer non-linearities in neural networks, feature correlation approximations can be akin to an approximation of mutual information between features, which represents a more general notion than correlation, given that such approximations capture non-linear relationships between data features. In examples disclosed herein, feature correlations are penalized via a loss function to encourage the model to force their decorrelation, yielding a more efficient coding process. In some examples, a simple feature ranking/dimensionality reduction algorithm that leverages NFD to decorrelate data features can be applied to rank these features using an absolute edge weight magnitude criterion.

In examples disclosed herein, NFD introduces a loss function that approximates pairwise feature correlation (e.g., per batch) in the input data, as shown in accordance with Equation 1:

L_{NFD}=λ(∥C∥)_{F}²−∥diag(C)∥₂²) Equation 1

In the example of Equation 1, C denotes a covariance matrix with respect to input layer edge weights of the neural network, where index F represents the Frobenius norm calculation. For example, W⁽¹⁾∈R^{|I|×|H|} can be used to represent the input layer weight of the neural network, whereas |I| and |H| denote the number of input dimensions and first layer (e.g., hidden) neurons, respectively. In examples disclosed herein, the covariance matrix of the weights can be calculated in accordance with Equation 2:

$${C}_{i , j} = \frac{1}{\vert H \vert} {Σ}_{i , j ∈ H} ( {W}_{i}^{( 1 )} - {μ}_{i} ) ⊗ ( {W}_{j}^{( 1 )} - {μ}_{j} ) \qquad Equation 2$$

In the example of Equation 2, μᵢ symbolizes a mean of the ith row of W⁽¹⁾ and Wᵢ⁽¹⁾ represents the ith column of W⁽¹⁾. As such, Equations 1 and 2 can be used to calculate the covariance matrix over the input features, where the first layer edge weights are treated as data points and C results in a square, |I|×|I| covariance matrix. In examples disclosed herein, feature correlations can be penalized using Equation 1, which is equivalent to minimizing the off-diagonal elements of the matrix C. As such, the difference between the magnitude of C and the magnitude of its diagonal is minimized (e.g., given the presence of univariate feature variance information).

As shown in the example of FIG. 1, pairwise feature correlation approximations are leveraged into the loss function as part of NFD. In the example of FIG. 1, input layer 105 represents the input layer of the feedforward neural network, including hidden layer(s) 110, 115 and an output layer 120 of the neural network. In the example of FIG. 1, the relationship W⁽¹⁾∈R^{|I|×|H|} represents the input layer weight of the neural network, where the covariance matrix of the weights is calculated in accordance with Equation 1. In some examples, the calculation can be updated with each successive input layer weight (e.g., W⁽¹⁾, W⁽²⁾, W⁽³⁾, etc.). In examples disclosed herein, NFD loss can be appended to any generic loss function (e.g., used to compute the distance between the current output of the algorithm and the expected output) to embed feature decorrelation into the model training, as shown in accordance with Equation 3, where L is the function of the whole parameter set and is proportional to the error between the true label and the predicted label, and X represents a hyperparameter:

L(y,f(x,θ))+λ(|C|_{F}²−∥diag(C)∥₂²) Equation 3

For example, the weight W⁽¹⁾ in the first layer connects inputs from the input layer 105 to the first hidden layer (e.g., hidden layer 110). The analysis performed herein can be based on the weights associated with the first layer. As described, Equation 1 calculates the correlation among the weights of the input layer to encourage those weights to form a diagonal matrix to achieve the highest decorrelation possible. The loss function encourages the activations as the data is being processed through the neural network and during model training. In the example of Equation 3, the correlation matrix (C) corresponds to the correlation of all the weight values in the first layer of the network, such that the main diagonal (diag(C)) is subtracted from the correlation matrix to obtain off-diagonal entries. The resulting off-diagonal entries should be as small as possible, given that the correlations among the different edge weights in the first layer of the neural network should be minimized for varying neural inputs (e.g., thereby minimizing off-diagonal correlation). As such, an additional loss function is added to the training of the model to cause the model to learn an embedding of features as the data passes through the model, resulting in the decorrelation of the features based on activations in the first layer of the neural network shown in the example of FIG. 1.

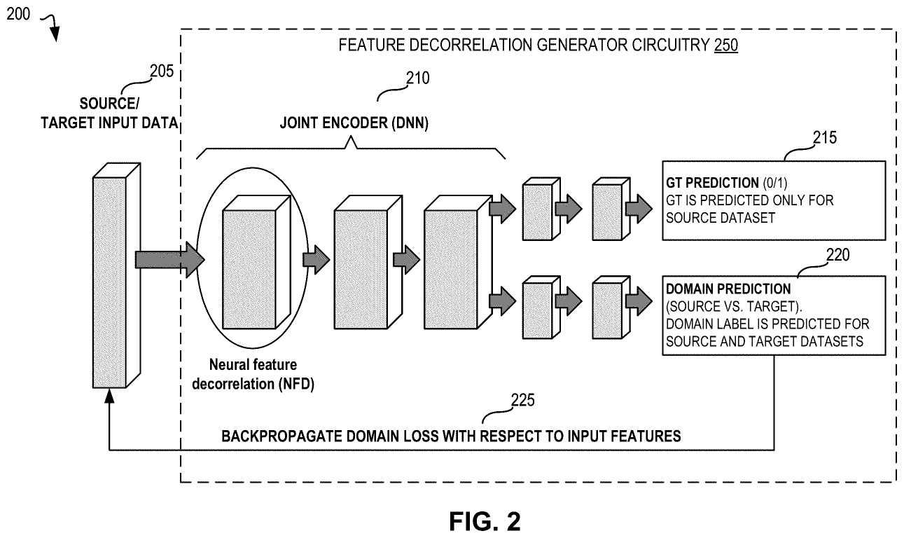

FIG. 2 is an example decorrelated distribution shift feature ranking (DDSFR) workflow 200 performed in accordance with teachings disclosed herein. For example, FIG. 2 illustrates a general schematic of the DDSFR feature importance ranking workflow, including source/target input data 205, joint encoder model 210, ground truth prediction 215, domain prediction 220, and backpropagation of the domain loss 225. An example feature decorrelation generator circuitry 250 performs feature decorrelation using neural feature decorrelation (NFD) as described in connection with FIG. 1. In the example of FIG. 2, the feature decorrelation generator circuitry 250 generates a joint encoder model 210 to simultaneously predict (e.g., at training time) the domain (e.g., source domain, target domain). The source domain corresponds to a data distribution on which the model is trained using labeled examples, whereas the target domain corresponds to a data distribution on which a model pre-trained on a different domain is used to perform a similar task. In the example of FIG. 2, the joint encoder model 210 predicts ground truth (GT) values for the source dataset. In some examples, the joint encoder model 210 uses a classification prediction (e.g., such as pass/fail for quality control inference). In examples disclosed herein, the joint encoder is model-agnostic and can therefore be optimized for any specific use case. In the example of FIG. 2, the joint encoder can be trained to predict, in a binary way (e.g., 0/1), a ground truth prediction (e.g., does a product work or not work, when performing quality control), while also determining whether a specific input datapoint originated from the source or the target dataset. In some examples, an assumption is made that at training time only ground truth labels for the source data are available (e.g., before the domain shift has occurred). Differentiating whether the input data 205 came from the source data distribution or the target data distribution allows for feature ranking associated with the domain prediction task (e.g., identifying which features change the most in connection with the domain shift). To perform feature ranking, the feature decorrelation generator circuitry 250 propagates gradient information from the domain loss back to the input features (e.g., associated with the input data 205), as shown using backpropagation of the domain loss 225. As such, once the model is trained to perform the joint prediction, the model becomes proficient at distinguishing which features are important for the ground truth prediction (e.g., does a product work or not, etc.), as well as which features have changed the most. The gradient information provided allows for approximating feature importance. To make the ranking more robust, the feature decorrelation generator circuitry 250 takes an average of the gradient information over the entire dataset, thereby generating a ranking of all the input features.

As part of quantifying decorrelated distribution shift feature ranking scores (DDSFR), the feature decorrelation generator circuitry 250 backpropagates the domain loss with respect to the data input features for each test datum. The feature decorrelation generator circuitry 250 obtains an average of the gradient values over the entire test dataset in accordance with Equation 4, where Xi denotes the ith data feature, L d represents the domain loss function (e.g., cross-entropy), j denotes the datum index, and Nis the size of the evaluation dataset:

$$DDSFR ( {x}_{i} ) = \frac{1}{N} {\sum }_{j = 1}^{N} \frac{\partial {L}_{d}}{\partial {x}_{i}^{( j )}} \qquad Equation 4$$

The resulting output is a set of generalizable importance scores for data features that are most influential for domain shift prediction, which can help pinpoint data anomalies, domain shift detection, and potentially identify features that cause and/or influence domain shift for real-world quality control applications (e.g., identifying whether a particular product is functional, etc.).

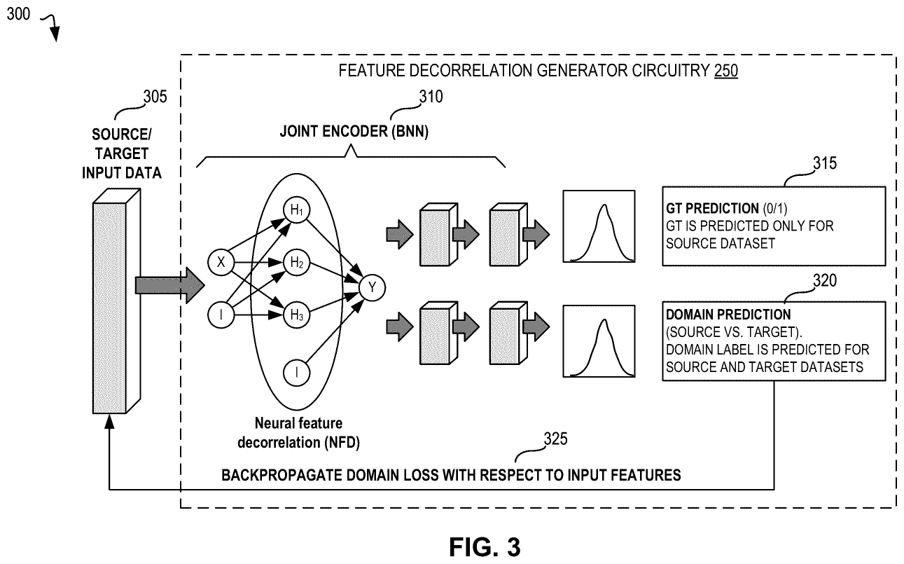

FIG. 3 is an example DDSFR workflow 300 using a Bayesian neural network (BNN) backbone for predictive uncertainty estimation in accordance with teachings disclosed herein. For example, the model-agnostic workflow shown in FIG. 2 can additionally be leveraged to permit predictive uncertainty estimates. Given the use of a single end-to-end deep neural network (DNN) as disclosed herein, conventional algorithms such as a Bayesian neural network (BNN) and Monte Carlo (MC) Dropout can easily be applied, whereas uncertainty estimates for classical methods are often computationally intensive or wholly intractable. Such uncertainty estimates can be used to further enhance DDSFR and/or amplify human-in-the-loop functionality. For example, to enable NFD for a BNN setting, the feature decorrelation generator circuitry 250 applies Equation 2 for feature decorrelation to the mean parameter of each first layer neuron. As shown in the example of FIG. 3, source/target input data 305 is provided to the joint encoder model 310, resulting in the identification of a ground truth prediction 315 and a domain prediction 320, followed by backpropagation of the domain loss 325. However, in the example of FIG. 3, the workflow is applied with a BNN backbone (e.g., where BNN is an uncertainty model) for predictive uncertainty estimation. For example, the feature decorrelation generator circuitry 250 converts the joint encoder model 310 to a Bayesian neural network model to obtain uncertainty prediction in addition to the class predictions.

As shown in connection with FIGS. 2 and 3, a simple and effective end-to-end method to simultaneously rank and decorrelate data features under distribution shift settings is introduced. For example, ground truth prediction values are reliably extrapolated for a target domain in the absence of target domain ground truth annotations. DDSFR as introduced herein can be executed by the feature decorrelation generator circuitry 250 as an embedded, multi-objective method and leveraged to produce predictive uncertainty estimates to enable anomaly or out-of-distribution (00D) detection. For example, feature decorrelation generator circuitry 250 uses NFD to directly isolate feature decorrelation at the model input layer, which can induce further efficiencies in model training, and improve information flow in the network. Unlike sparsity regularization (e.g., L1, L0), which implicitly ranks data features globally, NFD renders a qualitatively different efficient coding procedure that relies on exhaustive pairwise comparison of all the data features to check for individual redundancy.

Several advantages of the methods and apparatus disclosed herein include that DDSFR can be executed as an embedded method (e.g., looped into any training algorithm), DDSFR operates as a compositional, multi-objective paradigm, so that using a single model and single training regimen, it is possible to concurrently learn decorrelated feature rankings and source domain inference extrapolation. By contrast, most classical methods would require training independent models for each of these tasks. Furthermore, DDSFR can be leveraged to produce predictive uncertainty estimates to enable anomaly or out-of-distribution detection using standard methods such as Bayesian neural networks or Monte Carlo Dropout. Furthermore, the use of DDSFR and NFD does not require the introduction of additional model parameters, additional training, or additional post-hoc (e.g., pruning) steps, given that any standard neural network architecture can be adopted. Additionally, NFD directly isolates feature decorrelation at the model input layer, which can induce further efficiencies in model training, and improve information flow in the network. For example, effective feature selection/feature ranking methods are vital across machine learning and data science workflows. Particularly in large data and high-dimensional regimes, multi-collinearity and feature redundancy present common challenges to efficient data modelling. Methods and apparatus disclosed herein can be used as part of human-interpretable artificial intelligence (AI) systems by enabling deeper insights into data when using NFD-based methods for feature selection and/or as a dimensionality reduction technique. Methods and apparatus disclosed herein also effectively approximate exhaustive pairwise mutual information in a dataset, which is a difficult and computationally intensive quantity to approximate, particularly using classical methods. In some examples, methods and apparatus disclosed herein can be used for inclusion in AI-enabled yield optimization processes which consist of very large datasets that are difficult to model, due in part to the high presence of data feature redundancy and distribution shift.

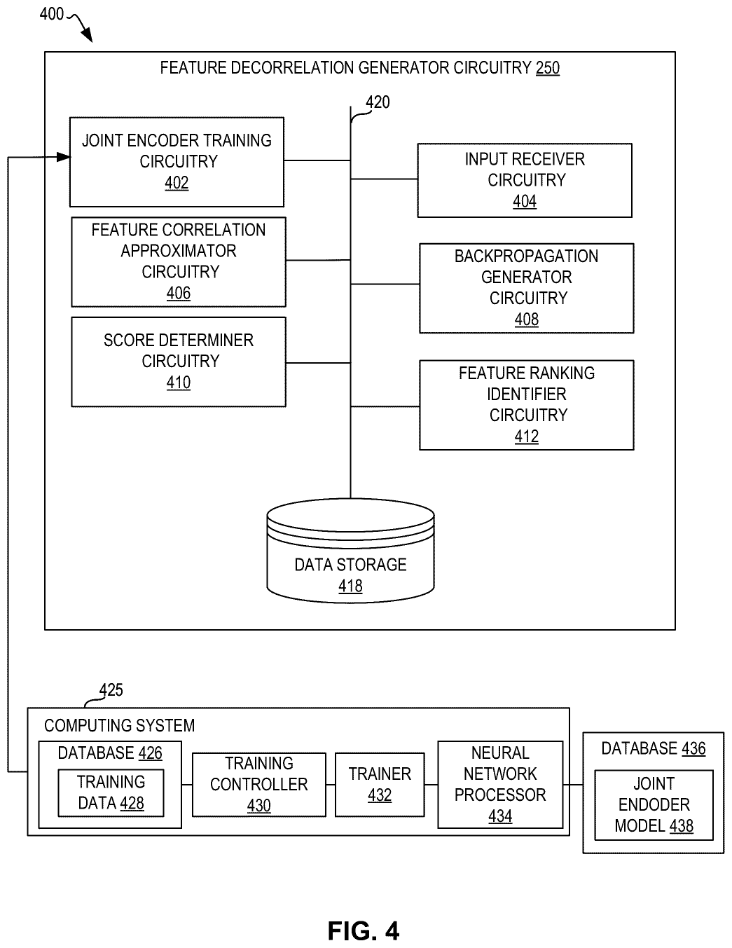

FIG. 4 is a block diagram of an example implementation of the feature decorrelation generator circuitry 250 of FIGS. 2 and 3. The feature decorrelation generator circuitry 250 of FIGS. 2 and 3 may be instantiated (e.g., creating an instance of, bring into being for any length of time, materialize, implement, etc.) by programmable circuitry such as a Central Processing Unit (CPU) executing first instructions. Additionally or alternatively, the feature decorrelation generator circuitry 250 of FIGS. 2 and 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the example of FIG. 4, the feature decorrelation generator circuitry 250 includes example joint encoder training circuitry 402, example input receiver circuitry 404, example feature correlation approximator circuitry 406, example backpropagation generator circuitry 408, example score determiner circuitry 410, example feature ranking identifier circuitry 412, and/or example data storage 418. The joint encoder training circuitry 402, input receiver circuitry 404, feature correlation approximator circuitry 406, backpropagation generator circuitry 408, score determiner circuitry 410, feature ranking identifier circuitry 412, and/or data storage 418 are in communication using an example bus 420.

The joint encoder training circuitry 402 trains a joint encoder model. For example, the joint encoder training circuitry 402 simultaneously predicts the domain (e.g., source domain or target domain) and ground truth values (e.g., for the source dataset). In some examples, the joint encoder training circuitry 402 uses a classification prediction (e.g., such as pass/fail). For example, the joint encoder training circuitry 402 is trained to predict, in a binary way (e.g., 0/1), a ground truth prediction, while also determining whether a specific input datapoint originated from the source or the target dataset.

As illustrated in FIG. 4, the joint encoder training circuitry 402 is in communication with a computing system 425 that trains a neural network to generate an example joint encoder model 438. In examples disclosed herein, any training algorithm may be used. In examples disclosed herein, training can be performed based on early stopping principles in which training continues until the model(s) stop improving. In examples disclosed herein, training can be performed remotely or locally. In some examples, training may initially be performed remotely. Further training (e.g., retraining) may be performed locally based on data generated as a result of execution of the models. Training is performed using hyperparameters that control how the learning is performed (e.g., a learning rate, a number of layers to be used in the machine learning model, etc.). In examples disclosed herein, hyperparameters that control complexity of the model(s), performance, duration, and/or training procedure(s) can be used. Such hyperparameters are selected by, for example, random searching and/or prior knowledge. In some examples re-training may be performed. Such re-training may be performed in response to new input datasets, drift in the model performance, and/or updates to model criteria and system specifications.

Training is performed using training data. In examples disclosed herein, the training data allows for an identification of a domain (e.g., a source domain or a target domain) associated with the input data (e.g., input data 205, 305 of FIGS. 2 and/or 3). In some examples, the training data is labeled. In some examples, the training data is sub-divided such that a portion of the data is used for validation purposes.

Once training is complete, the joint encoder model(s) are stored in one or more databases (e.g., database 426, 436 of FIG. 4). One or more of the models may then be executed by, for example, the joint encoder training circuitry 402. Once trained, the deployed model(s) may be operated in an inference phase to process data. In the inference phase, data to be analyzed (e.g., live data) is input to the model, and the model executes to create an output. This inference phase can be thought of as the artificial intelligence (AI) “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 4, the computing system 425 trains a neural network to generate the joint encoder model 438. The example computing system 425 includes a neural network processor 434. In examples disclosed herein, the neural network processor 434 implements a neural network. The computing system 425 of FIG. 4 also includes a neural network trainer 432. The neural network trainer 432 of FIG. 4 performs training of the neural network implemented by the neural network processor 434.

The computing system 425 of FIG. 4 includes a training controller 430. The training controller 430 instructs the neural network trainer 432 to perform training of the neural network based on training data 428. In the example of FIG. 4, the training data 428 used by the neural network trainer 432 to train the neural network is stored in a database 426. The example database 426 of the illustrated example of FIG. 4 is implemented by any memory, storage device and/or storage disc for storing data such as, for example, flash memory, magnetic media, optical media, etc. Furthermore, the data stored in the example database 426 may be in any data format such as, for example, binary data, comma delimited data, tab delimited data, structured query language (SQL) structures, image data, etc. While the illustrated example database 426 is illustrated as a single element, the database 426 and/or any other data storage elements described herein may be implemented by any number and/or type(s) of memories. The neural network trainer 432 trains the neural network implemented by the neural network processor 434 using the training data 428 to generate the joint encoder model 438 as a result of the neural network training. The joint encoder model 438 is stored in a database 436. The databases 426, 436 may be the same storage device or different storage devices.

The input receiver circuitry 404 receives source and target input data. For example, the input receiver circuitry 404 receives input data that includes source domain-based data and target domain-based data which is used for domain prediction and ground truth prediction as part of the neural feature decorrelation of the joint encoder model. In some examples, the input receiver circuitry 404 receives backpropagation of the domain loss with respect to the input features.

The feature correlation approximator circuitry 406 identifies correlated features and performs decorrelation using neural feature decorrelation. For example, the feature correlation approximator circuitry 406 identifies the type of neural network (e.g., deep neural network (DNN), Bayesian neural network (BNN), etc.) to apply and selects a joint encoder model (e.g., DDN-based model, BNN-based model, etc.) to use to approximate feature correlations. In some examples, the feature correlation approximator circuitry 406 penalizes feature correlations using an auxiliary loss function to force decorrelation of the features to take place.

The backpropagation generator circuitry 408 performs backpropagation of the domain loss with respect to the input features. For example, gradient information can be used to approximate feature importance. Backpropagation of the loss function occurs using the backward propagation of errors as an algorithm for supervised learning of artificial neural networks using gradient descent. For example, the backpropagation generator circuitry 408 calculates the gradient of the error function with respect to the neural network's weights.

The score determiner circuitry 410 determines decorrelated distribution shift feature ranking (DDSFR) scores. For example, the score determiner circuitry 410 uses Equation 4, as described in connection with FIG. 2, to obtain an average of the gradient values over the entire test dataset, where the resulting output is a set of generalizable importance scores for data features that are most influential for domain shift prediction. For example, the score determiner circuitry 410 takes an average of the gradient information over the entire dataset, thereby generating a ranking of all the input features.

The feature ranking identifier circuitry 412 identifies feature ranking information based on the DDSFR scores determined using the score determiner circuitry 410. In some examples, the feature ranking identifier circuitry 412 identifies the top-k most important features for a source-to-target domain shift setting. For example, the feature ranking identifier circuitry 412 outputs the ranking obtained based on exhaustive pairwise comparison of all the data features to check for individual feature redundancy.

The data storage 418 can be used to store any information associated with the joint encoder training circuitry 402, input receiver circuitry 404, feature correlation approximator circuitry 406, backpropagation generator circuitry 408, score determiner circuitry 410, and/or feature ranking identifier circuitry 412. The example data storage 418 of the illustrated example of FIG. 4 can be implemented by any memory, storage device and/or storage disc for storing data such as flash memory, magnetic media, optical media, etc. Furthermore, the data stored in the example data storage 418 can be in any data format such as binary data, comma delimited data, tab delimited data, structured query language (SQL) structures, image data, etc.

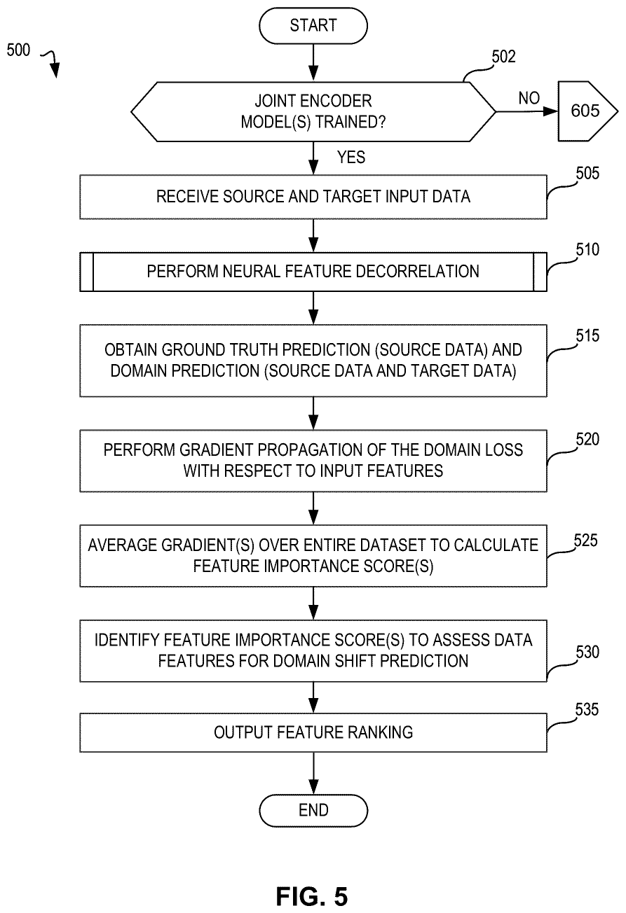

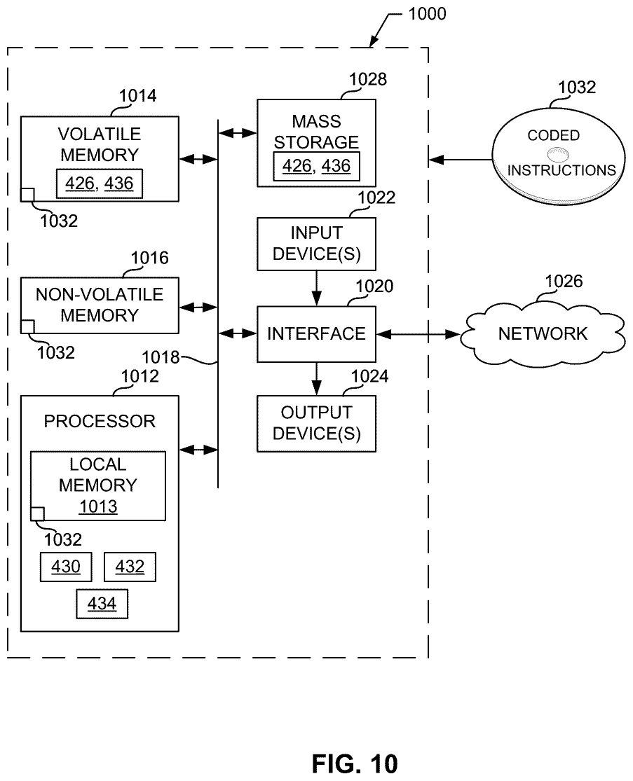

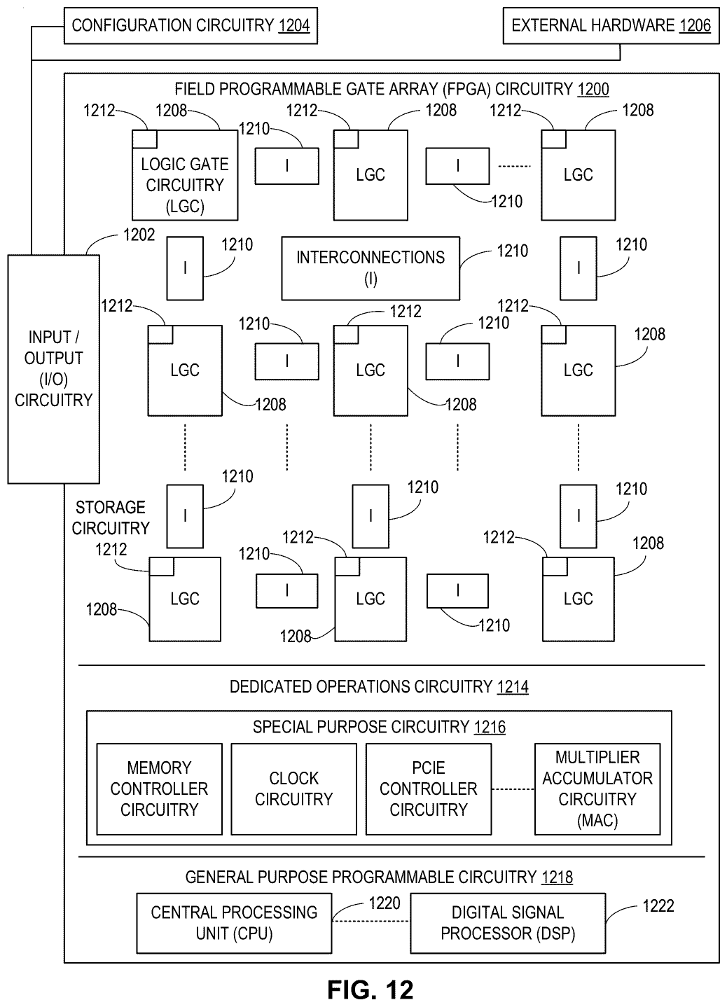

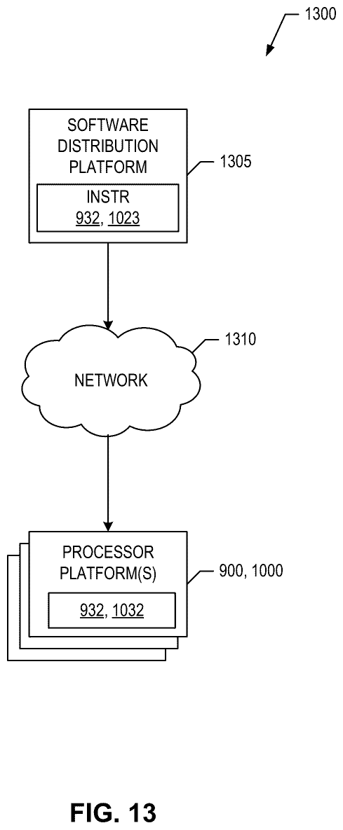

In some examples, the apparatus includes means for training a joint encoder. For example, the means for training a joint encoder may be implemented by joint encoder training circuitry 402. In some examples, the joint encoder training circuitry 402 may be instantiated by programmable circuitry such as the example programmable circuitry 912 of FIG. 9. For instance, the joint encoder training circuitry 402 may be instantiated by the example microprocessor 1100 of FIG. 11 executing machine executable instructions such as those implemented by at least block 502 of FIG. 5. In some examples, the joint encoder training circuitry 402 may be instantiated by hardware logic circuitry, which may be implemented by an ASIC, XPU, or the FPGA circuitry 1200 of FIG. 12 structured to perform operations corresponding to the machine readable instructions. Additionally or alternatively, the joint encoder training circuitry 402 may be instantiated by any other combination of hardware, software, and/or firmware. For example, the joint encoder training circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for receiving input. For example, the means for receiving input may be implemented by input receiver circuitry 404. In some examples, the input receiver circuitry 404 may be instantiated by programmable circuitry such as the example programmable circuitry 912 of FIG. 9. For instance, the input receiver circuitry 404 may be instantiated by the example microprocessor 1100 of FIG. 11 executing machine executable instructions such as those implemented by at least block 505 of FIG. 5. In some examples, the input receiver circuitry 404 may be instantiated by hardware logic circuitry, which may be implemented by an ASIC, XPU, or the FPGA circuitry 1200 of FIG. 12 structured to perform operations corresponding to the machine readable instructions. Additionally or alternatively, the joint encoder training circuitry 402 may be instantiated by any other combination of hardware, software, and/or firmware. For example, the input receiver circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for approximating feature correlation. For example, the means for approximating feature correlation may be implemented by feature correlation approximator circuitry 406. In some examples, the feature correlation approximator circuitry 406 may be instantiated by programmable circuitry such as the example programmable circuitry 912 of FIG. 9. For instance, the feature correlation approximator circuitry 406 may be instantiated by the example microprocessor 1100 of FIG. 11 executing machine executable instructions such as those implemented by at least block 510 of FIG. 5. In some examples, the feature correlation approximator circuitry 406 may be instantiated by hardware logic circuitry, which may be implemented by an ASIC, XPU, or the FPGA circuitry 1200 of FIG. 12 structured to perform operations corresponding to the machine readable instructions. Additionally or alternatively, the joint encoder training circuitry 402 may be instantiated by any other combination of hardware, software, and/or firmware. For example, the feature correlation approximator circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for performing backpropagation. For example, the means for performing backpropagation may be implemented by backpropagation generator circuitry 408. In some examples, the backpropagation generator circuitry 408 may be instantiated by programmable circuitry such as the example programmable circuitry 912 of FIG. 9. For instance, the backpropagation generator circuitry 408 may be instantiated by the example microprocessor 1100 of FIG. 11 executing machine executable instructions such as those implemented by at least block 520 of FIG. 5. In some examples, the backpropagation generator circuitry 408 may be instantiated by hardware logic circuitry, which may be implemented by an ASIC, XPU, or the FPGA circuitry 1200 of FIG. 12 structured to perform operations corresponding to the machine readable instructions. Additionally or alternatively, the backpropagation generator circuitry 408 may be instantiated by any other combination of hardware, software, and/or firmware. For example, the backpropagation generator circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a score. For example, the means for determining a score may be implemented by score determiner circuitry 410. In some examples, the score determiner circuitry 410 may be instantiated by programmable circuitry such as the example programmable circuitry 912 of FIG. 9. For instance, the score determiner circuitry 410 may be instantiated by the example microprocessor 1100 of FIG. 11 executing machine executable instructions such as those implemented by at least block 530 of FIG. 5. In some examples, the score determiner circuitry 410 may be instantiated by hardware logic circuitry, which may be implemented by an ASIC, XPU, or the FPGA circuitry 1200 of FIG. 12 structured to perform operations corresponding to the machine readable instructions. Additionally or alternatively, the score determiner circuitry 410 may be instantiated by any other combination of hardware, software, and/or firmware. For example, the score determiner circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for ranking a feature. For example, the means for ranking a feature may be implemented by feature ranking identifier circuitry 412. In some examples, the feature ranking identifier circuitry 412 may be instantiated by programmable circuitry such as the example programmable circuitry 912 of FIG. 9. For instance, the feature ranking identifier circuitry 412 may be instantiated by the example microprocessor 1100 of FIG. 11 executing machine executable instructions such as those implemented by at least block 535 of FIG. 5. In some examples, the feature ranking identifier circuitry 412 may be instantiated by hardware logic circuitry, which may be implemented by an ASIC, XPU, or the FPGA circuitry 1200 of FIG. 12 structured to perform operations corresponding to the machine readable instructions. Additionally or alternatively, the feature ranking identifier circuitry 412 may be instantiated by any other combination of hardware, software, and/or firmware. For example, the feature ranking identifier circuitry 412 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing feature decorrelation generator circuitry 250 of FIG. 2 is illustrated in FIG. 4, one or more of the elements, processes and/or devices illustrated in FIG. 4 may be combined, divided, re-arranged, omitted, eliminated and/or implemented in any other way. Further, the example joint encoder training circuitry 402, input receiver circuitry 404, feature correlation approximator circuitry 406, backpropagation generator circuitry 408, score determiner circuitry 410, and/or, more generally, the feature decorrelation generator circuitry 250 of FIG. 2 may be implemented by hardware, software, firmware and/or any combination of hardware, software and/or firmware. Thus, for example, any of the example joint encoder training circuitry 402, input receiver circuitry 404, feature correlation approximator circuitry 406, backpropagation generator circuitry 408, score determiner circuitry 410, and/or, more generally, the feature decorrelation generator circuitry 250 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the feature decorrelation generator circuitry 250 of FIG. 2 may include one or more elements, processes, and/or devices in addition to, or instead of, those illustrated in FIG. 4, and/or may include more than one of any or all of the illustrated elements, processes and devices.

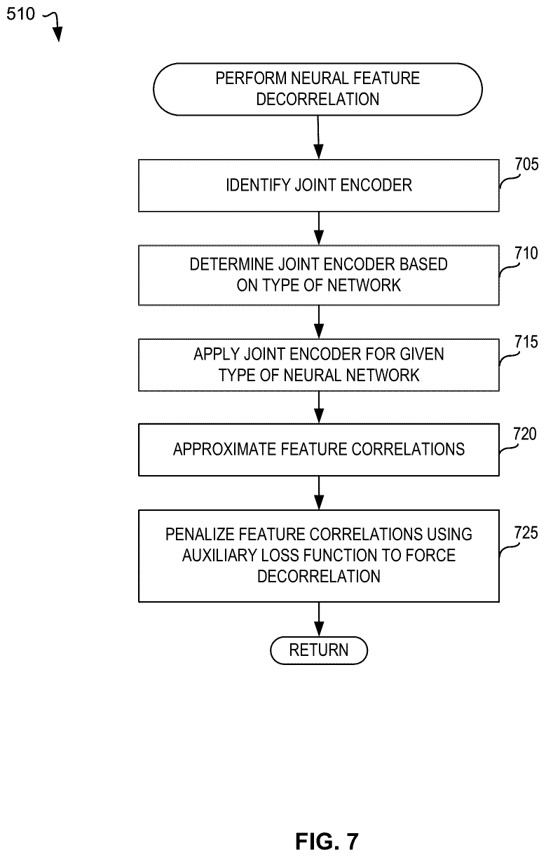

Flowcharts representative of example machine readable instructions, which may be executed by programmable circuitry to implement and/or instantiate the feature decorrelation generator circuitry 250 of FIG. 2 and/or representative of example operations which may be performed by programmable circuitry to implement and/or instantiate the feature decorrelation generator circuitry 250 of FIG. 2, are shown in FIGS. 5-7. The machine readable instructions may be one or more executable programs or portion(s) of one or more executable programs for execution by programmable circuitry, such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5-7, many other methods of implementing the example feature decorrelation generator circuitry 250 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

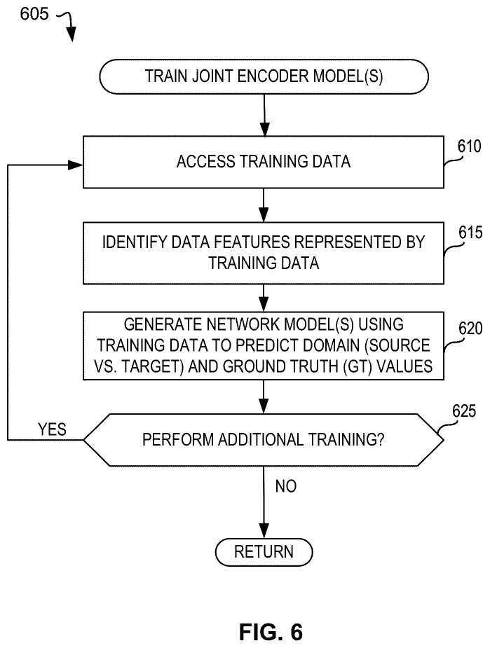

FIG. 5 is a flowchart representative of example machine readable instructions and/or example operations 500 that may be executed, instantiated, and/or performed by programmable circuitry to implement the example feature decorrelation generator circuitry 250 of FIG. 2. The machine readable instructions and/or the operations 500 of FIG. 5 begin at block 502, at which the joint encoder training circuitry 402 determines whether the joint encoder model 438 has been trained. If the joint encoder training circuitry 402 determines that the joint encoder model has not been trained, control proceeds to 605, where the joint encoder training circuitry 402 proceeds to train the joint encoder model. Once the joint encoder model is trained, the input receiver circuitry 404 receives input data in the form of source domain-based input data and target domain-based input data, at block 505. The feature correlation approximator circuitry 406 performs neural feature decorrelation based on the received input data, at block 510. For example, as described in more detail in connection with FIG. 6, the feature correlation approximator circuitry 406 identifies highly correlated features and decorrelates the features. As part of the feature decorrelation, the feature correlation approximator circuitry 406 obtains a ground truth prediction associated with the source data-based domain and a domain prediction associated with the source data and/or target data domain, at block 515, as shown in more detail in connection with FIGS. 2 and/or 3. The backpropagation generator circuitry 408 proceeds to backpropagate the domain loss with respect to the input features, at block 520. The score determiner circuitry 410 averages the backpropagated gradient(s) over the entire dataset to calculate feature importance score(s), at block 525. Subsequently, the feature ranking identifier circuitry 412 identifies feature importance score(s) to assess data features for the domain shift prediction, at block 530. In some examples, the feature ranking identifier circuitry 412 performs ranking of the features to pinpoint data anomalies, generate a domain shift detection, and/or identify features for quality control applications.

FIG. 6 is a flowchart representative of example machine readable instructions and/or example operations 605 that may be executed, instantiated, and/or performed by programmable circuitry to implement the example joint encoder training circuitry 402 of FIG. 4 to train a joint encoder model. The machine readable instructions and/or the operations 605 of FIG. 6 begin at block 610, at which the joint encoder training circuitry 402 accesses training data 428. The training data 428 can include identification of input data originating from a source domain and input data originating from a target domain, as well as data used to predict ground truth values for source domain-based data generation. In some examples, the training data is labeled. In some examples, the training data is sub-divided such that a portion of the data is used for validation purposes. The trainer 432 identifies data features represented by the training data 428, at block 615. In some examples, the training controller 430 instructs the trainer 432 to perform training of the neural network using the training data 428 to generate a joint encoder model 438, at block 620. In some examples, additional training is performed to refine the joint encoder model 438, at block 625.

FIG. 5 is a flowchart representative of example machine readable instructions and/or example operations 510 that may be executed, instantiated, and/or performed by programmable circuitry to implement the example feature decorrelation generator circuitry 250 of FIG. 2 to perform neural feature decorrelation. The machine readable instructions and/or the operations 510 of FIG. 5 begin at block 705, at which the feature correlation approximator circuitry 406 identifies a joint encoder (e.g., the trained joint encoder model 438). The feature correlation approximator circuitry 406 determines the joint encoder based on a type of neural network used as part of neural feature decorrelation (e.g., a deep neural network, a Bayesian neural network, etc.), at block 710. Once the feature correlation approximator circuitry 406 identifies the appropriate joint encoder model, the feature correlation approximator circuitry 406 applies the joint encoder model, at block 715. For example, to enable NFD for a BNN setting, the feature correlation approximator circuitry 406 applies Equation 2 for feature decorrelation to the mean parameter of each first layer neuron, as shown in connection with FIG. 3. In some examples, the feature correlation approximator circuitry 406 converts the joint encoder model to a Bayesian neural network model to obtain uncertainty prediction in addition to class-based predictions. The feature correlation approximator circuitry 406 proceeds to approximate feature correlations (e.g., identify features that are highly correlated), at block 720. In some examples, the feature correlation approximator circuitry 406 penalizes feature correlations using an auxiliary loss function to force decorrelation (e.g., by applying pairwise feature correlation approximations in the loss function, etc.), at block 725.

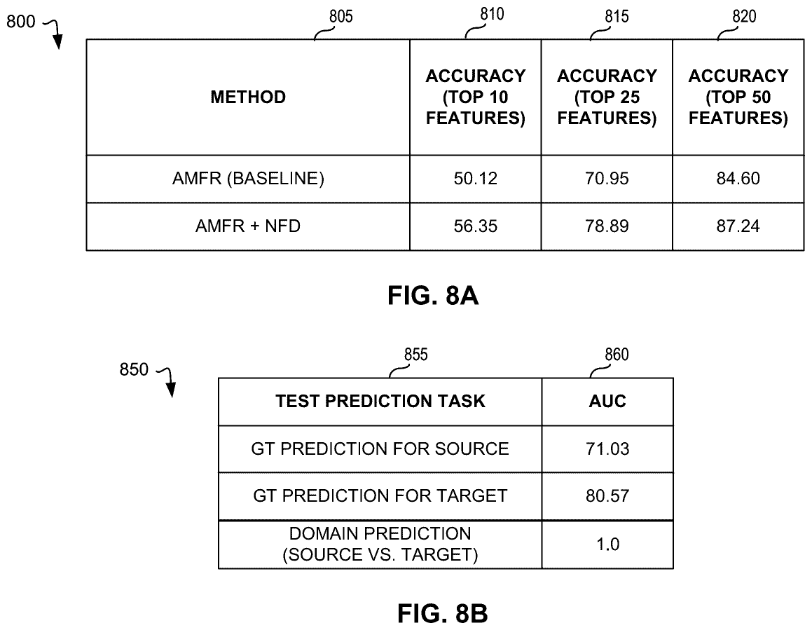

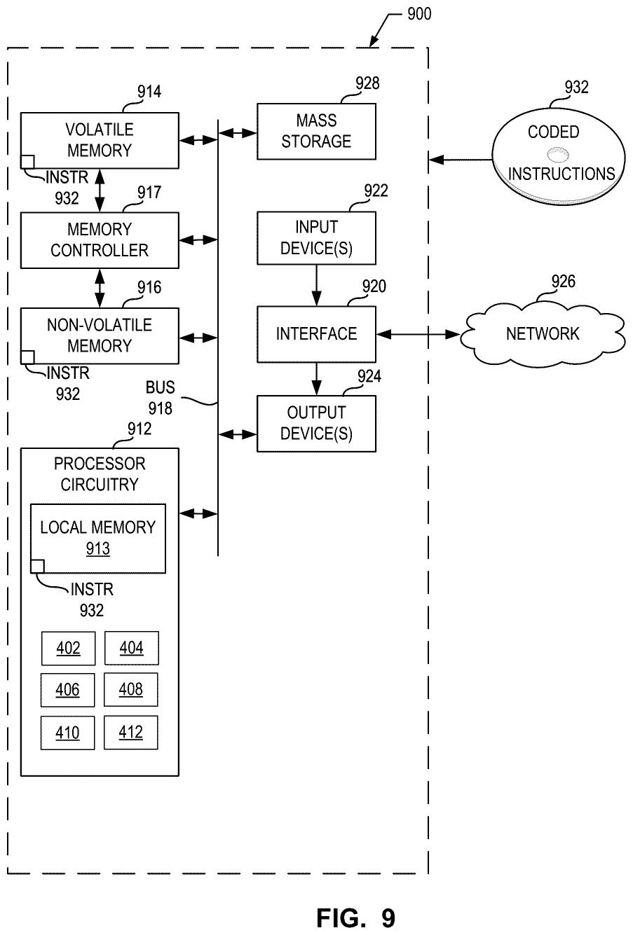

FIG. 8A illustrates example results 800 associated with evaluating the effectiveness of neural feature decorrelation (NFD) for feature ranking and feature selection based on a standard Modified National Institute of Standards and Technology (MNIST) dataset. For example, to validate the effectiveness of NFD for feature ranking and feature selection, a given method 805 (e.g., absolute magnitude feature ranking (AMFR), AMFR and NFD combined, etc.) is evaluate using a standard MNIST dataset on a very stringent dimensionality reduction task using a compact feed-forward neural network. The compact feed-forward neural network can include two linear layers, yielding specific feature dimensions when using a standard rectified linear unit (ReLU) activation function, Adam optimizer, and/or cross-entropy loss. Across several trials, the neural network can be implemented using the aforementioned NFD procedure, including the loss function (e.g., as described in connection with Equation 3), followed by the absolute magnitude feature ranking (AMFR) process using Equation 4. Overall, despite the severity of the dimensionality reduction tested (e.g., selected to highlight the effectiveness of the NFD method), ten features for MNIST testing represents a 99% feature reduction. In the example of FIG. 8A, results 800 include accuracy for the top ten features 810, the top twenty-five features 815, and/or the top fifty features 820. Application of NFD consistently shows strong performance gains over the baseline method (e.g., AMFR alone), indicating NFD's effectiveness at enforcing decorrelation in the data input features, yielding more efficient latent encodings within the neural network.

FIG. 8B illustrates example results 850 associated with decorrelated distribution shift feature ranking on high-dimensional data shift ground truth prediction and/or domain prediction tasks to evaluate the effectiveness of decorrelated distribution shift feature ranking. In the example of FIG. 8B, test prediction task(s) include ground truth prediction for the source domain, ground truth prediction for the target domain, and domain prediction (e.g., source domain or target domain), with results for an area under the curve (AUC) 860 shown for each test prediction task 855. To validate the effectiveness of DDSFR, datasets can be selected for yield prediction evaluation under data distribution shift. The selected datasets can include large quantity data points (e.g., 300,000 or more data points) of high-dimensional data (e.g., 16,000 features). A modest-size, feed-forward neural network of dimensions can be used. The results shown in connection with FIG. 8B are comparable with state-of-the-art decision tree performance (e.g., LightGBM). However, these models require the training of a single model for each task (e.g., GT source prediction, GT target prediction, domain prediction, etc.), whereas methods and apparatus disclosed herein using DDSFR yield an end-to-end multi-task solution. Additionally, as noted, known methods do not provide straightforward uncertainty estimates, seamless feature decorrelation, or fine-grain, per-datum analysis.

FIG. 9 is a block diagram of an example programmable circuitry platform 900 structured to execute and/or instantiate the example machine-readable instructions and/or the example operations of FIGS. 5 and/or 7 to implement the example feature decorrelation generator circuitry 250 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs microprocessors, CPUs, GPUs, DSPs, and/or microcontrollers from any desired family or manufacturer. The programmable circuitry 912 may be implemented by one or more semiconductor based (e.g., silicon based) devices. In this example, the processor circuitry 912 implements the joint encoder training circuitry 402, the input receiver circuitry 404, the feature correlation approximator circuitry 406, the backpropagation generator circuitry 408, the score determiner circuitry 410, and the feature ranking identifier circuitry 412.

The programmable circuitry 912 of the illustrated example includes a local memory 913 (e.g., a cache, registers, etc.). The programmable circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 900 of the illustrated example also includes one or more mass storage devices 928 to store software and/or data. Examples of such mass storage devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 932, which may be implemented by the machine readable instructions of FIGS. 5 and/or 7, may be stored in the mass storage device 928, in the volatile memory 914, in the non-volatile memory 916, and/or on at least one non-transitory computer readable storage medium such as a CD or DVD which may be removable.

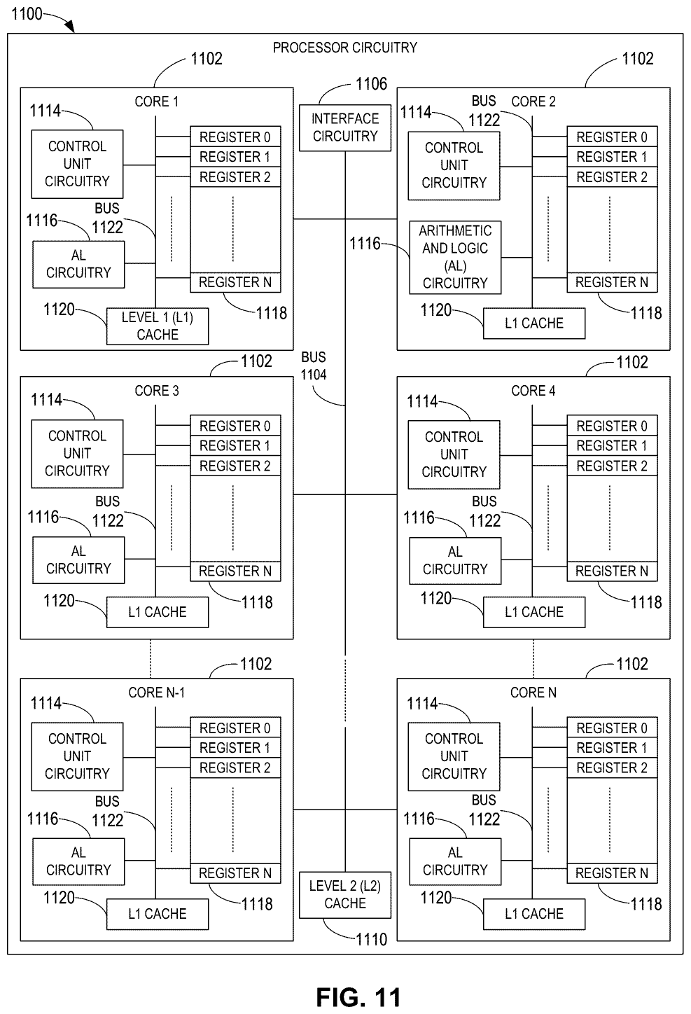

FIG. 10 is a block diagram of an example programmable circuitry platform 1000 structured to execute and/or instantiate the example machine-readable instructions and/or the example operations of FIG. 4 to implement the example computing system 425 of FIG. 4. The programmable circuitry platform 1000 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example neural network processor 434, the example trainer 432, and the example training controller 430.

The programmable circuitry 1012 of the illustrated example includes a local memory 1013 (e.g., a cache, registers, etc.). The programmable circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1000 of the illustrated example also includes one or more mass storage devices 1028 to store software and/or data. Examples of such mass storage devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1032, which may be implemented by the machine readable instructions of FIG. 6, may be stored in the mass storage device 1028, in the volatile memory 1014, in the non-volatile memory 1016, and/or on at least one non-transitory computer readable storage medium such as a CD or DVD which may be removable

FIG. 11 is a block diagram of an example implementation of the programmable circuitry 912, 1012 of FIGS. 9, 10. In this example, the programmable circuitry 912, 1012 of FIGS. 9, 10 is implemented by a microprocessor 1100. For example, the microprocessor 1100 may be a general purpose microprocessor (e.g., general purpose microprocessor circuitry). The microprocessor 1100 executes some or all of the machine readable instructions of the flowchart of FIGS. 5, 6 and/or 7 to effectively instantiate the circuitry of FIG. 4 logic circuits to perform the operations corresponding to those machine readable instructions. In some such examples, the circuitry of FIG. 4 is instantiated by the hardware circuits of the microprocessor 1100 in combination with the instructions. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 5, 6, and/or 7.

The cores 1102 may communicate by a first example bus 1104. In some examples, the first bus 1104 may implement a communication bus to effectuate communication associated with one(s) of the cores 1102. For example, the first bus 1104 may implement at least one of an Inter-Integrated Circuit (I2C) bus, a Serial Peripheral Interface (SPI) bus, a PCI bus, or a PCIe bus. Additionally or alternatively, the first bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_ cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating-point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 912, 1012 of FIGS. 9, 10. In this example, the programmable circuitry 912, 1012 of FIGS. 9, 10 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 5, 6, and/or 7 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 5, 6, and/or 7. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5, 6 and/or 7. As such, the FPGA circuitry 1200 may be configured and/or structured to effectively instantiate some or all of the operations/functions corresponding to the machine readable instructions of the flowcharts of FIGS. 5, 6 and/or 7 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 5, 6, and/or 7 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 5, 6, 7 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 912, 1012 of FIGS. 9 and 10, many other approaches are contemplated. For example, FPGA circuitry may include an on-board CPU, such as one or more of the example CPU 1220 of FIG. 12. Therefore, the programmable circuitry 912, 1012 of FIGS. 9 and/or 10 may additionally be implemented by combining at least the example microprocessor 1100 of FIG. 11 and the example FPGA circuitry 1200 of FIG. 12. In some such hybrid examples, one or more cores 1202 of FIG. 12 may execute a first portion of the machine readable instructions represented by the flowchart(s) of FIGS. 5-7 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 5-7, and/or an ASIC may be configured and/or structured to perform third operation(s)/function(s) corresponding to a third portion of the machine readable instructions represented by the flowcharts of FIGS. 5-7.

It should be understood that some or all of the circuitry of FIG. 4 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 4 may be implemented within one or more virtual machines and/or containers executing on the microprocessor 1100 of FIG. 11.

In some examples, the programmable circuitry 912, 1012 of FIGS. 9, 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 912, 1012 of FIGS. 9, 10 which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

A block diagram illustrating an example software distribution platform 1305 to distribute software such as the example machine readable instructions 932, 1032 of FIGS. 9, 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 932, 1032 of FIGS. 9, 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 932, 1032 which may correspond to the example machine readable instructions of FIGS. 5-7, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1305. For example, the software, which may correspond to the example machine readable instructions of FIG. 5-7, may be downloaded to the example programmable circuitry platform 1300, which is to execute the machine readable instructions 1332 to implement the feature decorrelation generator circuitry 250. In some examples, one or more servers of the software distribution platform 1305 periodically offer, transmit, and/or force updates to the software (e.g., the example machine readable instructions 932, 1032 of FIGS. 9, 10) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed that permit simultaneous ranking and decorrelation of data features under distribution shift settings. In examples disclosed herein, the most important features for a source-to-target domain shift setting are identified. In examples disclosed herein, a joint encoder model can be used to simultaneously predict the domain (e.g., source domain versus target domain) and ground truth values. Methods and apparatus disclosed herein include neural feature decorrelation (NFD) for enforcing seamless feature decorrelation via an auxiliary function that minimizes off-diagonal feature covariances of first layer weights of the model. Furthermore, methods and apparatus disclosed herein apply gradient propagation of the domain loss (e.g., the source domain loss versus the target domain loss) with respect to input features. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for decorrelated distribution shift feature ranking are disclosed herein. Further examples and combinations thereof include the following:

Example 1 includes an apparatus comprising interface circuitry, machine readable instructions, and programmable circuitry to at least one of instantiate or execute the machine readable instructions to access source input data and target input data, identify a domain shift prediction based on at least one of a feature decorrelation of the source input data or a feature decorrelation of the target input data, the domain shift prediction being a source domain prediction or a target domain prediction, initiate gradient propagation of a domain loss to determine data features for the domain shift prediction, and rank input data features for the domain shift prediction.

Example 2 includes the apparatus of example 1, wherein the programmable circuitry is to train a joint encoder model for the domain shift prediction based on the source input data and the target input data.

Example 3 includes the apparatus of example 2, wherein the programmable circuitry is to train the join encoder model for a Bayesian neural network for neural feature decorrelation associated with predictive uncertainty estimation.

Example 4 includes the apparatus of example 2, wherein the programmable circuitry is to perform feature decorrelation in the joint encoder model for a Bayesian neural network by applying feature decorrelation to a mean parameter of a first layer neuron of the Bayesian neural network.

Example 5 includes the apparatus of example 1, wherein to perform the feature decorrelation, the programmable circuitry is to penalize feature correlations using an auxiliary loss function.

Example 6 includes the apparatus of example 1, wherein the programmable circuitry is to average gradients over an entire dataset to identify a feature importance score.

Example 7 includes the apparatus of example 1, wherein the feature decorrelation includes a loss function to approximate a pairwise feature correlation in the input data.

Example 8 includes a method comprising accessing source input data and target input data, identifying a domain shift prediction based on at least one of a feature decorrelation of the source input data or a feature decorrelation of the target input data, the domain shift prediction a source domain prediction or a target domain prediction, initiating gradient propagation of a domain loss to determine data features for the domain shift prediction, and ranking input data features for the domain shift prediction.

Example 9 includes the method of example 8, further including training a joint encoder model for the domain shift prediction based on the source input data and the target input data.

Example 10 includes the method of example 9, further including training the join encoder model for a Bayesian neural network for neural feature decorrelation associated with predictive uncertainty estimation.

Example 11 includes the method of example 9, further including performing neural feature decorrelation in the joint encoder model for a Bayesian neural network by applying feature decorrelation to a mean parameter of a first layer neuron of the Bayesian neural network.

Example 12 includes the method of example 11, wherein the neural feature decorrelation includes penalizing feature correlations using an auxiliary loss function.

Example 13 includes the method of example 12, wherein neural feature decorrelation includes a loss function to approximate a pairwise feature correlation in the input data.

Example 14 includes the method of example 8, further including averaging gradients over an entire dataset to identify a feature importance score.

Example 15 includes a non-transitory machine readable storage medium comprising instructions to cause programmable circuitry to at least access source input data and target input data, identify a domain shift prediction based on at least one of a feature decorrelation of the source input data or a feature decorrelation of the target input data, the domain shift prediction a source domain prediction or a target domain prediction, initiate gradient propagation of a domain loss to determine data features for the domain shift prediction, and rank input data features for the domain shift prediction.

Example 16 includes the non-transitory machine readable storage medium of example 15, wherein the instructions are to cause the programmable circuitry to train a joint encoder model for the domain shift prediction based on the source input data and the target input data.

Example 17 includes the non-transitory machine readable storage medium as defined in example 16, wherein the instructions are to cause the programmable circuitry to train the join encoder model for a Bayesian neural network for neural feature decorrelation associated with predictive uncertainty estimation.

Example 18 includes the non-transitory machine readable storage medium as defined in example 16, wherein the instructions are to cause the programmable circuitry to perform neural feature decorrelation in the joint encoder model for a Bayesian neural network by applying feature decorrelation to a mean parameter of a first layer neuron of the Bayesian neural network.

Example 19 includes the non-transitory machine readable storage medium as defined in example 18, wherein neural feature decorrelation includes a loss function to approximate a pairwise feature correlation in the input data.

Example 20 includes the non-transitory machine readable storage medium as defined in example 15, wherein the instructions are to cause the programmable circuitry to average gradients over an entire dataset to identify a feature importance score.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
interface circuitry;
machine readable instructions; and
programmable circuitry to at least one of instantiate or execute the machine readable instructions to:
access source input data and target input data;
identify a domain shift prediction based on at least one of a feature decorrelation of the source input data or a feature decorrelation of the target input data, the domain shift prediction being a source domain prediction or a target domain prediction;
initiate gradient propagation of a domain loss to determine data features for the domain shift prediction; and
rank input data features for the domain shift prediction.

2. The apparatus of claim 1, wherein the programmable circuitry is to train a joint encoder model for the domain shift prediction based on the source input data and the target input data.

3. The apparatus of claim 2, wherein the programmable circuitry is to train the join encoder model for a Bayesian neural network for neural feature decorrelation associated with predictive uncertainty estimation.

4. The apparatus of claim 2, wherein the programmable circuitry is to perform feature decorrelation in the joint encoder model for a Bayesian neural network by applying feature decorrelation to a mean parameter of a first layer neuron of the Bayesian neural network.

5. The apparatus of claim 1, wherein to perform the feature decorrelation, the programmable circuitry is to penalize feature correlations using an auxiliary loss function.

6. The apparatus of claim 1, wherein the programmable circuitry is to average gradients over an entire dataset to identify a feature importance score.

7. The apparatus of claim 1, wherein the feature decorrelation includes a loss function to approximate a pairwise feature correlation in the input data.

8. A method comprising:
accessing source input data and target input data;
identifying a domain shift prediction based on at least one of a feature decorrelation of the source input data or a feature decorrelation of the target input data, the domain shift prediction a source domain prediction or a target domain prediction;
initiating gradient propagation of a domain loss to determine data features for the domain shift prediction; and
ranking input data features for the domain shift prediction.

9. The method of claim 8, further including training a joint encoder model for the domain shift prediction based on the source input data and the target input data.

10. The method of claim 9, further including training the join encoder model for a Bayesian neural network for neural feature decorrelation associated with predictive uncertainty estimation.

11. The method of claim 9, further including performing neural feature decorrelation in the joint encoder model for a Bayesian neural network by applying feature decorrelation to a mean parameter of a first layer neuron of the Bayesian neural network.

12. The method of claim 11, wherein the neural feature decorrelation includes penalizing feature correlations using an auxiliary loss function.

13. The method of claim 12, wherein neural feature decorrelation includes a loss function to approximate a pairwise feature correlation in the input data.

14. The method of claim 8, further including averaging gradients over an entire dataset to identify a feature importance score.

15. A non-transitory machine readable storage medium comprising instructions to cause programmable circuitry to at least:
access source input data and target input data;
identify a domain shift prediction based on at least one of a feature decorrelation of the source input data or a feature decorrelation of the target input data, the domain shift prediction a source domain prediction or a target domain prediction;
initiate gradient propagation of a domain loss to determine data features for the domain shift prediction; and
rank input data features for the domain shift prediction.

16. The non-transitory machine readable storage medium of claim 15, wherein the instructions are to cause the programmable circuitry to train a joint encoder model for the domain shift prediction based on the source input data and the target input data.

17. The non-transitory machine readable storage medium as defined in claim 16, wherein the instructions are to cause the programmable circuitry to train the join encoder model for a Bayesian neural network for neural feature decorrelation associated with predictive uncertainty estimation.

18. The non-transitory machine readable storage medium as defined in claim 16, wherein the instructions are to cause the programmable circuitry to perform neural feature decorrelation in the joint encoder model for a Bayesian neural network by applying feature decorrelation to a mean parameter of a first layer neuron of the Bayesian neural network.

19. The non-transitory machine readable storage medium as defined in claim 18, wherein neural feature decorrelation includes a loss function to approximate a pairwise feature correlation in the input data.

20. The non-transitory machine readable storage medium as defined in claim 15, wherein the instructions are to cause the programmable circuitry to average gradients over an entire dataset to identify a feature importance score.
